(19) United States
(12) Patent Application Publication
(10) Pub. No.: US 2019/0174976 A1
(43) Pub. Date: Jun. 13, 2019

(54) Collapsible Potty Training Assembly

(71) Applicants: Isaac Dwamena, Miami, FL (US); Catherine Gikuri, Miami, FL (US)

(72) Inventors: Isaac Dwamena, Miami, FL (US); Catherine Gikuri, Miami, FL (US)

(21) Appl. No.: 15/840,850

(22) Filed: Dec. 13, 2017

(51) Int. Cl. A47K 11/06; G09B 19/00

(52) U.S. Cl. CPC A47K 11/06; G09B 19/0076

(57) ABSTRACT

A collapsible potty training assembly for collecting feces and urine during potty training includes a panel and a bag that is collapsibly coupled to the panel. The panel is selectively gripped to position the bag beneath a user when the panel is gripped. Thus, the bag receives feces and urine from the user when the user is potty training. A drawstring is slidably coupled to the bag and the drawstring selectively closes the bag. A pad is positioned in the bag and the pad is comprised of a fluid absorbent material to absorb the urine.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to potty training devices and more particularly pertains to a new potty training device for collecting feces and urine during potty training.

### (h) BRIEF SUMMARY OF THE INVENTION

An embodiment of the disclosure meets the needs presented above by generally comprising a panel and a bag that is collapsibly coupled to the panel. The panel is selectively gripped to position the bag beneath a user when the panel is gripped. Thus, the bag receives feces and urine from the user when the user is potty training. A drawstring is slidably coupled to the bag and the drawstring selectively closes the bag. A pad is positioned in the bag and the pad is comprised of a fluid absorbent material to absorb the urine.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a collapsible potty training assembly according to an embodiment of the disclosure.

FIG. 2 is a perspective in-use view of an embodiment of the disclosure.

FIG. 3 is a top view of an embodiment of the disclosure.

FIG. 4 is a front view of an embodiment of the disclosure.

FIG. 5 is a cross sectional view taken along line 5-5 of FIG. 3 of an embodiment of the disclosure.

### (j) DETAILED DESCRIPTION OF THE INVENTION

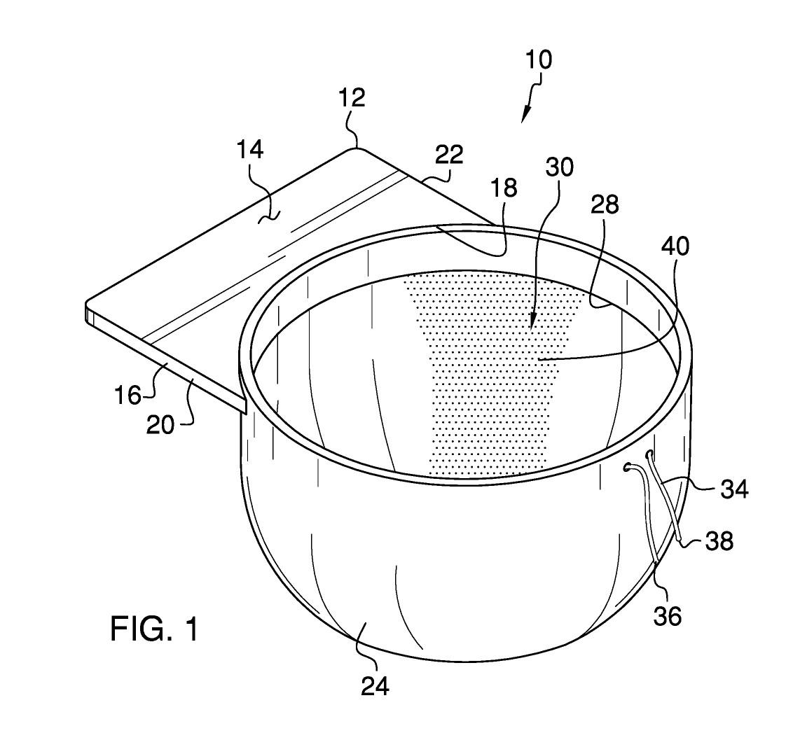

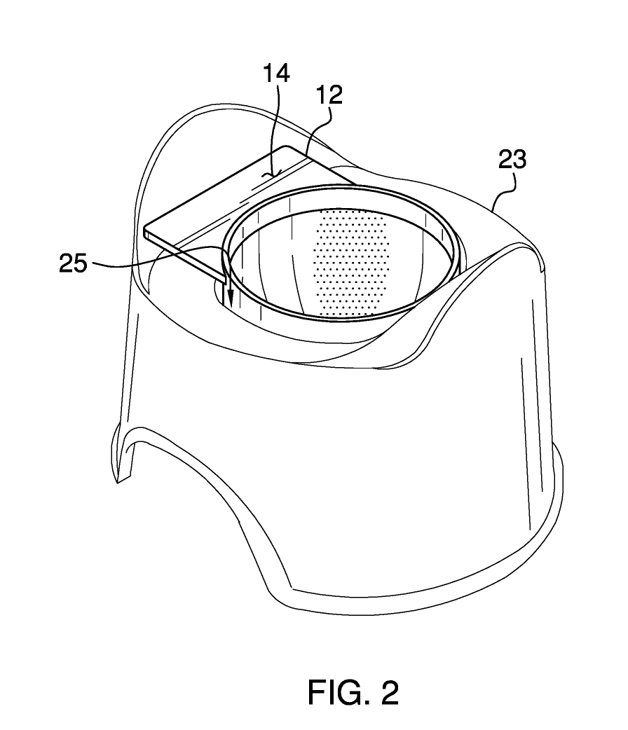

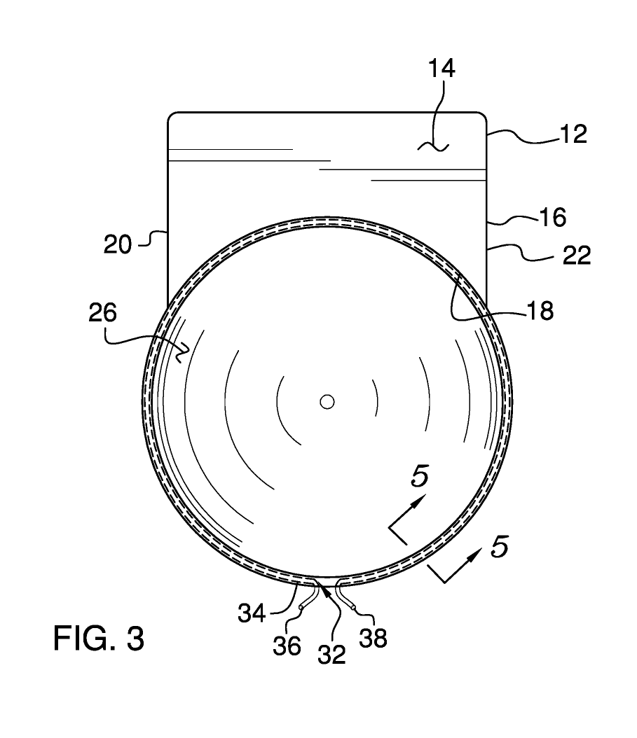

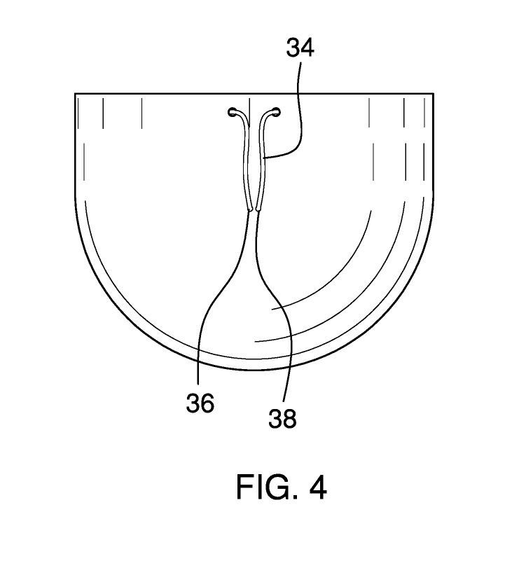

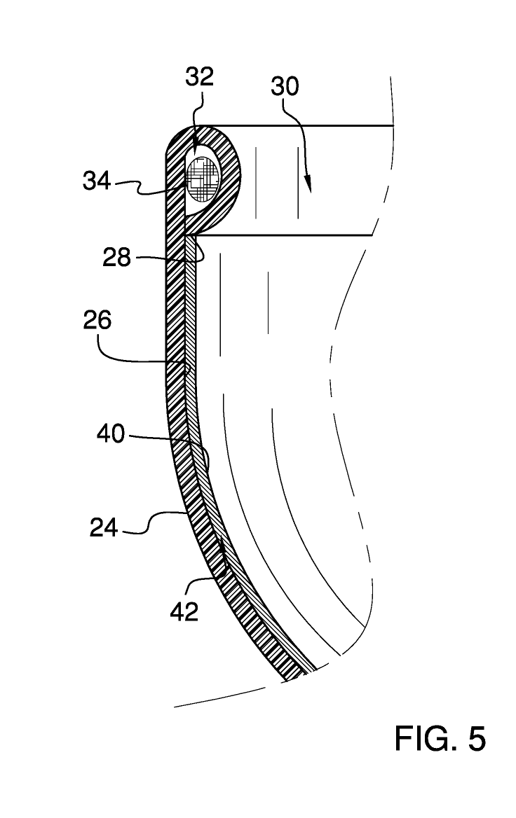

With reference now to the drawings, and in particular to FIGS. 1 through 5 thereof, a new potty training device embodying the principles and concepts of an embodiment of the disclosure and generally designated by the reference numeral 10 will be described.

As shown in FIGS. 1 through 5, the collapsible potty training assembly generally comprises a panel 12 that is selectively gripped. The panel 12 has a top surface 14 and a perimeter edge 16 and the perimeter edge 16 has a front side 18, a first lateral side 20 and a second lateral side 22. The front side 18 is concavely arcuate between the first 20 and second 22 lateral sides. The panel 12 may be comprised of a rigid material such as plastic or the like. Additionally, the panel 12 may be selectively placed on a training toilet 23 or the panel 12 may be held beneath a child that is potty training.

A bag 24 is collapsibly coupled to the panel 12 such that the bag 24 is positioned beneath the child when the panel 12 is gripped. Additionally, the bag 24 extends downwardly through an opening 25 in the training toilet 23 when the panel 12 is placed on the training toilet 23. Thus, the bag 24 receives feces and urine from the user when the user is potty training. The bag 24 has inwardly facing surface 26 and a peripheral edge 28 and the peripheral edge 28 is continuous such that the peripheral edge 28 defines an opening 30 into the bag 24.

The bag 24 is folded over onto itself such that the peripheral edge 28 is bonded to the inwardly facing surface 26 to define a channel 32 extending around the bag 24. The bag 24 is releasably attached to the front side 18 of the panel 12 such that the opening 30 in the bag 24 is aligned with the top surface 14 of the panel 12. The bag 24 may be releasably attached to the panel 12 through any conventional means, including but not being limited to, an adhesive and perforations in the bag 24. A drawstring 34 is slidably coupled to the bag 24 and the drawstring 34 selectively closes the bag 24. The drawstring 34 is slidably positioned in the channel 32 and the drawstring 34 has a first end 36 and a second end 38. Moreover, the drawstring 34 extends through the bag 24 such that each of the first end 36 and the second end 38 are exposed.

A pad 40 is positioned in the bag 24. The pad 40 is comprised of a fluid absorbent material to absorb the urine. Additionally, the pad 40 is infused with a chemical fragrance 42 to mask an odor of the feces and the urine. The chemical fragrance 42 may be a floral fragrance, an odor masking agent and any other chemical means of reducing olfactory detection of the odor from the feces and urine. The pad 40 is bonded to the inwardly facing surface 26 of the bag 24 and the pad 40 completely covers the inwardly facing surface 26.

In use, the panel 12 is gripped and to position the bag 24 beneath the child when the child is potty training in a remote location, such as a campground, a picnic site and any other location that may or may not have a restroom. The bag 24 collects the feces and urine from the child and the drawstring 34 is manipulated to close the bag 24. In this way the feces and urine are collected for disposal. Alternatively, the panel 12 is positioned on the training toilet 23 such that the bag 24 extends downwardly through the opening 30 in the training toilet 23. Additionally, the panel 12 and bag 24 may be used in lieu of a bedpan or the like for a bedridden individual.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A collapsible potty training assembly being configured to collect feces and urine during potty training in a remote location, said assembly comprising:
a panel being configured to be gripped, said panel having a top surface and a perimeter edge, said perimeter edge having a front side, a first lateral side and a second lateral side, said front side being concavely arcuate between said first and second lateral sides such that a middle of said front side is extended into said panel towards a center of said panel;
a bag being collapsibly coupled to said panel wherein said bag is configured be positioned beneath a user when said panel is gripped, said bag being configured to receive feces and urine from the user when the user is potty training;
a drawstring being slidably coupled to said bag wherein said drawstring is configured to be manipulated, said drawstring selectively closing said bag; and
a pad being positioned in said bag, said pad being comprised of a fluid absorbent material wherein said pad is configured to absorb the urine.

2. (canceled)

3. The assembly according to claim 1, wherein said bag has an inwardly facing surface and a peripheral edge, said peripheral edge being continuous such that said peripheral edge defines an opening into said bag, said bag being folded over onto itself such that said peripheral edge is bonded to said inwardly facing surface to define a channel extending around said bag, said bag being releasably attached to said front side of said panel, said opening in said bag being coplanar with said top surface of said panel.

4. The assembly according to claim 3, wherein said drawstring is slidably positioned in said channel, said drawstring having a first end and a second end, said drawstring extending through said bag such that each of said first end and said second end are exposed.

5. The assembly according to claim 3, wherein said pad is infused with a chemical fragrance wherein said chemical fragrance is configured to mask an odor of the feces and the urine, said pad being bonded to said inwardly facing surface of said bag, said pad completely covering said inwardly facing surface.

6. A collapsible potty training assembly being configured to collect feces and urine during potty training in a remote location, said assembly comprising:
a panel being configured to be gripped, said panel having a top surface and a perimeter edge, said perimeter edge having a front side, a first lateral side and a second lateral side, said front side being concavely arcuate between said first and second lateral sides such that a middle of said front side is extended into said panel towards a center of said panel;
a bag being collapsibly coupled to said panel wherein said bag is configured be positioned beneath a user when said panel is gripped, said bag being configured to receive feces and urine from the user when the user is potty training, said bag having inwardly facing surface and a peripheral edge, said peripheral edge being continuous such that said peripheral edge defines an opening into said bag, said bag being folded over onto itself such that said peripheral edge is bonded to said inwardly facing surface to define a channel extending around said bag, said bag being releasably attached to said front side of said panel, said opening in said bag being coplanar with said top surface of said panel;
a drawstring being slidably coupled to said bag wherein said drawstring is configured to be manipulated, said drawstring selectively closing said bag, said drawstring being slidably positioned in said channel, said drawstring having a first end and a second end, said drawstring extending through said bag such that each of said first end and said second end are exposed; and
a pad being positioned in said bag, said pad being comprised of a fluid absorbent material wherein said pad is configured to absorb the urine, said pad being infused with a chemical fragrance wherein said chemical fragrance is configured to mask an odor of the feces and the urine, said pad being bonded to said inwardly facing surface of said bag, said pad completely covering said inwardly facing surface.
